(19) United States
(12) Patent Application Publication
(10) Pub. No.: US 2003/0154834 A1
(43) Pub. Date: Aug. 21, 2003

(54) Automatic cutoff saw

(76) Inventor: LeRoy E. Cothrell, West Linn, OR (US)

Correspondence Address: Bruce W. DeKock, Suite 1600, 601 SW Second Ave., Portland, OR, 97204-3157, US

(21) Appl. No.: 10/082,037

(22) Filed: Feb. 20, 2002

(51) Int. Cl. B26D 7/06

(52) U.S. Cl. 83/435.2; 83/363; 83/373; 83/422

(57) ABSTRACT

An automatic cutoff saw includes a workpiece positioner comprising a plurality synchronized conveying belts driven by a single motor to position a workpiece for cutting by reciprocating, rotating saw blade.

### BACKGROUND OF THE INVENTION

The present invention relates to an automatic cutoff saw and, more particularly, to an improved workpiece positioner and cutting mechanism for an automatic cutoff saw.

An automatic cutoff saw automatically positions a workpiece so that a cutting mechanism can cut the workpiece to a preselected length. Typically, a workpiece positioner for an automatic cutoff saw includes an infeed to move a workpiece horizontally into position for cutting and restraining the workpiece while the cutting mechanism cuts the workpiece to length and an outfeed to move the cut workpiece away from the cutting mechanism. The cutting mechanism is commonly a rotating saw blade that is reciprocated horizontally or vertically so that the cutting elements of the blade are displaced through a cross-section of the workpiece. The productivity of an automatic cutoff saw is determined, in part, by the speed with which the workpiece positioner can accurately position a workpiece and the time interval required to move the cutting elements of a saw blade across a section of the workpiece and return the blade to a position where the workpiece positioner can move the next workpiece into position for cutting without interference.

In U.S. Pat. No. 5,181,445, incorporated herein by reference, the present inventor disclosed a workpiece positioner for a cutoff saw comprising a plurality of powered conveying belts in contact with the top and bottom surfaces of a workpiece. The workpiece is moved into position and restrained during cutting by friction between the conveying belts and the workpiece. The cutting mechanism includes a rotating saw blade that is raised from below the workpiece to cut the workpiece and then lowered to a clearance position by a pneumatic actuator. A programmable controller starts and stops the conveying belts of the workpiece positioner to position the workpiece relative to the cutting plane of the cutting mechanism and controls the reciprocation of the cutting mechanism to cut the workpiece to length.

While the prior art workpiece positioner rapidly and accurately positions work pieces, each of the conveying belts is independently driven and differences in the dynamic operating characteristics of the conveying belts and their associated drives become increasingly significant as the speed of the conveying belts is increased to increase workpiece positioner throughput. As a result, the accuracy of the workpiece positioner suffers which impedes further increases in the throughput.

Once the workpiece has been positioned for cutting, the productivity of the cutoff saw is determined by the time interval required to reciprocate the cutting elements of the saw blade across a section of the workpiece from a start position and return the blade to a position clear of the workpiece permitting the workpiece positioner to move the next workpiece into position for the next cut. The speed of the pneumatic actuator is limited by the need to avoid excessive shock when the cutting mechanism changes direction at the limits of the actuator's travel. Increasing cutoff saw productivity by reducing the reciprocating time for the cutting mechanism has heretofore been limited by the need to control the speed of the pneumatic actuator to limit shock to the cutting mechanism.

Another prior art cutting saw involved the use of a motor driven cut off saw which utilized a clutch to engage and disengage a motor running at a uniform speed with the lift mechanism. This device suffered from two problems. First, the device began a cutting cycle with the cutting saw at the bottom of travel of the lift mechanism. This increased the amount of time needed for the cutting saw to engage the board to be cut, since the cutting saw was required to be lifted through a substantial gap before engaging the board. Second, the clutch was engaged, the saw then traveled at a uniform speed, which was limited due to the use of the clutch and due to the speed limit at which the cutting saw could cleanly cut through the board.

What is desired, therefore, is a workpiece positioner and a cutting mechanism for an automatic cutoff saw enabling a workpiece to be more accurately and rapidly positioned and cut.

### BRIEF DESCRIPTION OF THE SEVERAL VIEWS OF THE DRAWINGS

FIG. 1 is a front elevation view of an automatic cutoff saw.

FIG. 2 is a top view of the automatic cutoff saw of FIG. 1.

FIG. 3 is a sectional view of the automatic cutoff saw of FIG. 1 along line 3-3.

FIG. 4 is a right side elevation of the automatic cutoff saw of FIG. 1.

FIG. 5 is a sectional view of the automatic cutoff saw of FIG. 1 along line 5-5 illustrating the power transmission for the workpiece positioner conveying belts.

FIG. 6 is an elevation view of the cutting mechanism of the cutoff saw of FIG. 1 with the saw blade in an initial position.

FIG. 7 is an elevation view of the cutting mechanism of the cutoff saw of FIG. 1 with the saw blade in a partially raised position.

FIG. 8 is an elevation view of the cutting mechanism of the cutoff saw of FIG. 1 with the saw blade fully raised.

### DETAILED DESCRIPTION OF THE PREFERRED EMBODIMENT

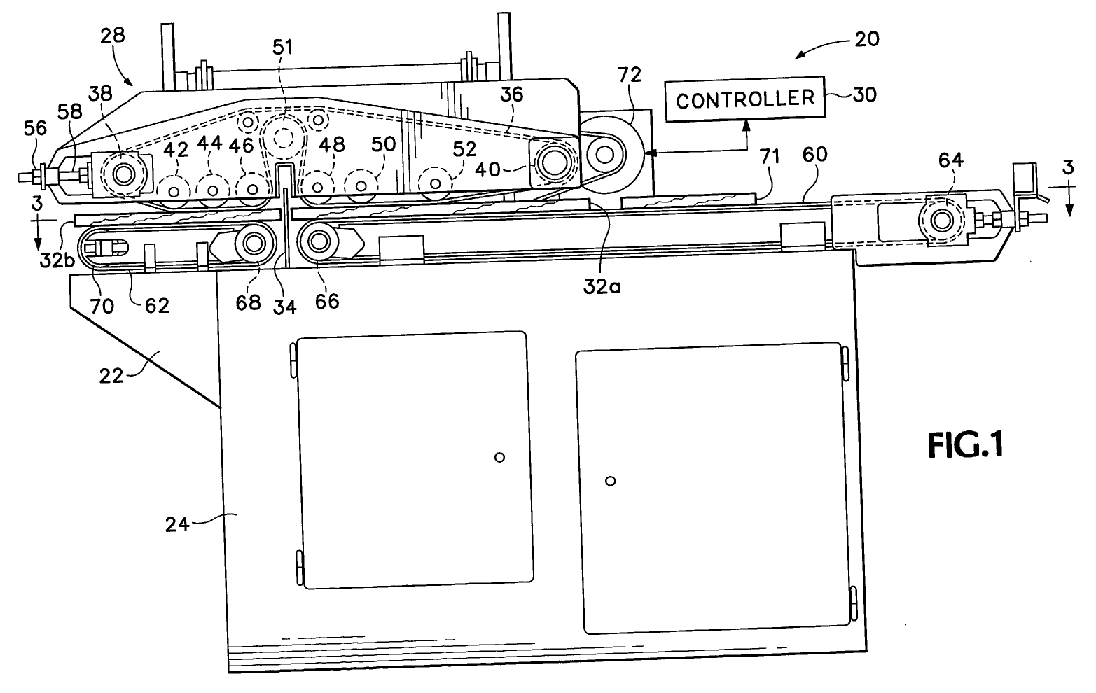

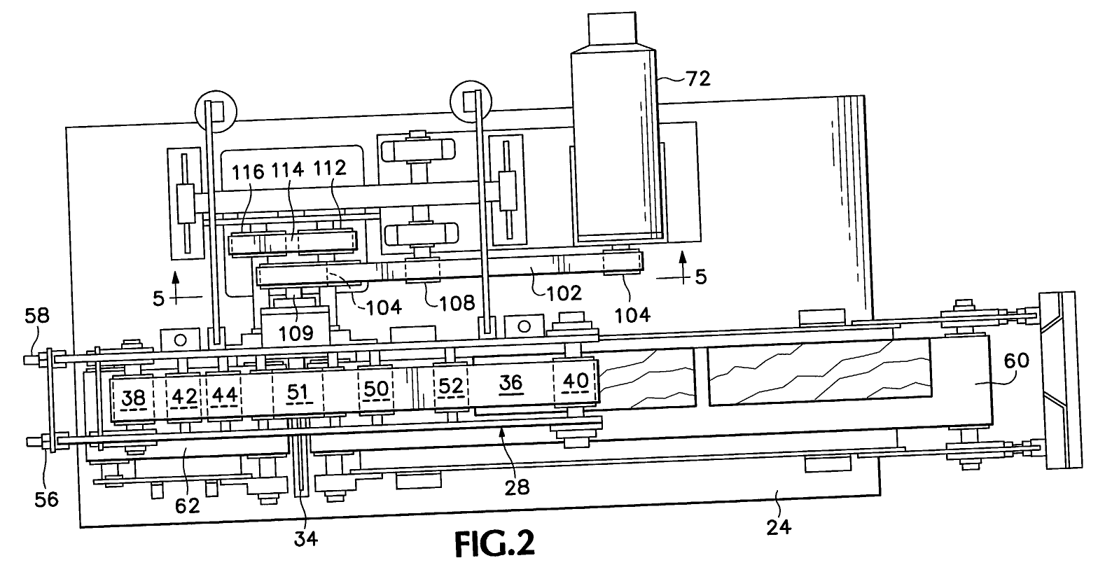

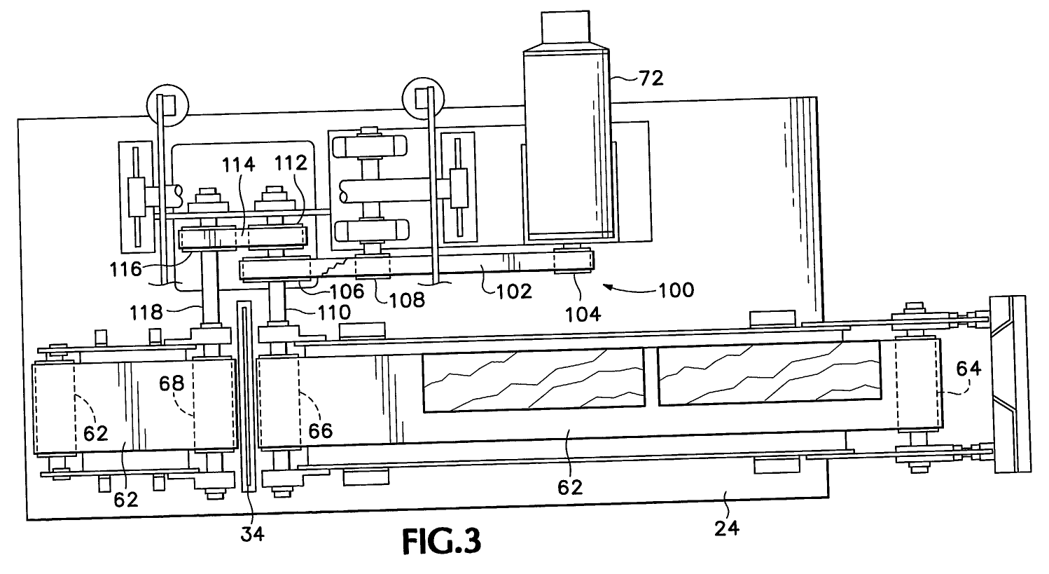

Referring to FIGS. 1-4, an automatic cutoff saw 20 comprises, generally, a frame 22 including a cabinet 24 to support the saw and shield it from dust; a cutting mechanism 26; a workpiece positioner 28; and a controller 30 to coordinate the operation of the workpiece positioner and the cutting mechanism in positioning and cutting a workpiece 32 at a predetermined location. The workpiece positioner 28 includes an infeed to move a workpiece 32 (illustrated as comprising a first portion 32a and a second portion 32b) in a horizontal direction intersecting the cutting plane of the saw blade 34 until the predetermined cutting location is aligned with the cutting plane of the reciprocating cutting mechanism and an outfeed to move the cut portion of the workpiece 32b and scraps away from the cutting mechanism. The workpiece positioner 28 of the cutoff saw 20 comprises a plurality of conveying belts arranged for contact with the upper and lower surfaces of the workpiece 32.

An upper conveying belt 36 comprises a continuous belt that is looped over a pair of end rollers 38 and 40 and urged into contact with the upper surface of the workpiece 32 by a plurality of idlers 42, 44, 46, 48, 50, and 52. The upper conveying belt 36 is powered by a drive roller 51 that is offset from the plane of the idlers 46 and 48 creating a loop in the belt 36 to provide clearance for the saw blade 34 when it is raised to cut the workpiece 32. Tension in the upper conveying belt 36 is maintained by a tension adjustment comprising a nut 56 bearing on the frame 22 that engages a screw 58 attached to one of the end rollers 38.

Likewise, the lower infeed conveying belt 60 and the lower outfeed conveying belt 62 are continuous loops of belting looped over pairs of end rollers 64 and 66, and 68 and 70, respectively. A roller 66 and 68 of each pair of end rollers is powered to drive the conveying belts and the second end roller typically includes a belt tension adjustment mechanism. The lower infeed conveying belt 60 preferably includes an exposed length extending away from the cutting plane of the saw blade 34 so that an operator or an automated device (not illustrated) can load work pieces 32 and 71 onto the belt. As the lower infeed conveying belt 60 is driven, friction between the belt and a workpiece 32 conveys the workpiece horizontally toward the cutting plane of the saw blade 34. As the workpiece 32 progresses horizontally, the upper conveying belt 36 comes into contact with the upper surface of the workpiece 32 and the workpiece is further conveyed horizontally by the combined operation of the two conveying belts. When a first portion of the workpiece 32b progresses beyond the cutting plane of the saw blade 34, the bottom surface is supported by the lower outfeed conveying belt 62. Vertical motion of the workpiece 32 during cutting is resisted by the upper 36 and lower 60 and 62 conveying belts. Friction between the conveying belts 36, 60, and 62 and the workpiece 32 prevents the workpiece from moving horizontally, except in response to motion of the conveying belts. Cut portions of the workpiece 32b are moved away from the cutting plane by the motion of the upper 36 and lower outfeed 62 conveyors.

In prior art cutoff saws, each of the upper, lower infeed, and lower outfeed conveying belts is driven by a separate motor. However, increasing the speed and acceleration of the conveying belts to increase the throughput of the workpiece positioner, increases the importance of differences in the dynamic characteristics of the conveying belts and their associated drives. As a result, synchronizing the operation of the conveying belts becomes increasingly difficult which reduces the accuracy of the workpiece positioning. The present inventor realized that the productivity the cutoff saw is limited by the ability to rapidly and synchronously start, stop, and drive the upper 36 and lower 60 and 62 conveying belts of the workpiece positioner. In the cutoff saw 20, a single motor 72 drives the upper 36 and lower 60 and 62 conveyors of the workpiece positioner 28 to assure accurate, synchronized operation of the conveying belts and increase workpiece positioner throughput.

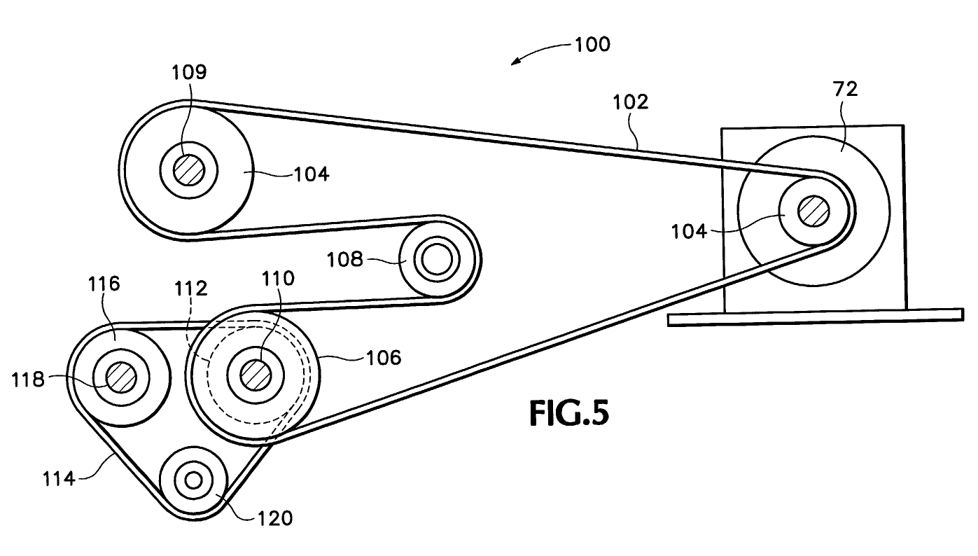

Referring to FIG. 5, the workpiece positioner 28 includes a transmission 100 facilitating substantially synchronous operation of the three conveying belts by the drive motor 72. While gearing or other known power transmission methods may be used, the transmission 100 incorporates a power transmission belt 102 driven by rotation of a motor pulley 104 attached to the armature shaft of the workpiece positioner drive motor 72. The power transmission belt 102 is looped in driving engagement around an upper conveying belt drive pulley 104 and a lower infeed conveying belt drive pulley 106. Tension in the power transmission belt 102 is maintained by an idler pulley 108. The upper conveying belt drive pulley 104 is affixed to a shaft 109 which is also affixed to the drive roller 51 for the upper conveying belt 36. Rotation of the motor pulley 104 causes rotation of the drive roller 51 and rotation of the loop of belting comprising the upper conveying belt 36 conveying the workpiece 32 horizontally. Likewise, the lower infeed conveying belt drive pulley 106 is attached to a shaft 110 that rotates the drive roller 66 powering the lower infeed conveying belt 60.

The lower outfeed conveying belt 62 is driven by a second transmission comprising a second pulley 112 attached to the drive roller shaft 110 of the lower infeed conveying belt 60. A second power transmission belt 114 engaging the second pulley 112 powers a lower outfeed conveying belt drive pulley 116 that is attached to and rotates the drive roller shaft 118 of the lower outfeed conveying belt 62. An idler 120 maintains tension in the second power transmission belt 114. As a result, the upper 36 and lower infeed 60 and outfeed 62 conveying belts are simultaneously driven at substantially equal speeds by a single workpiece positioner motor 72 assuring synchronous starting, stopping, and motion of the workpiece positioner conveying belts and more rapid and accurate positioning of the workpiece 32.

Once a workpiece is positioned for cutting, the productivity of the cutoff saw is determined by the time required to reciprocate the cutting elements of the saw blade through the workpiece from a starting position and back to a position where the blade is disengaged from the workpiece so that the workpiece positioner can be restarted to outfeed the cut pieces and position the next workpiece for the next cut. In prior art cutoff saws, a pneumatic actuator has been used to reciprocate a rotating saw blade. However, a pneumatic actuator extends and retracts at a single speed which must be slow enough to avoid excessive shock as the actuator reaches the end of its stroke at the limits of the saw blade's travel. The present inventor concluded, that improving the productivity of the cutoff saw would require a blade reciprocating mechanism that minimized the time to displace the saw blade and provided smooth direction changes at the limits to the blade's reciprocation.

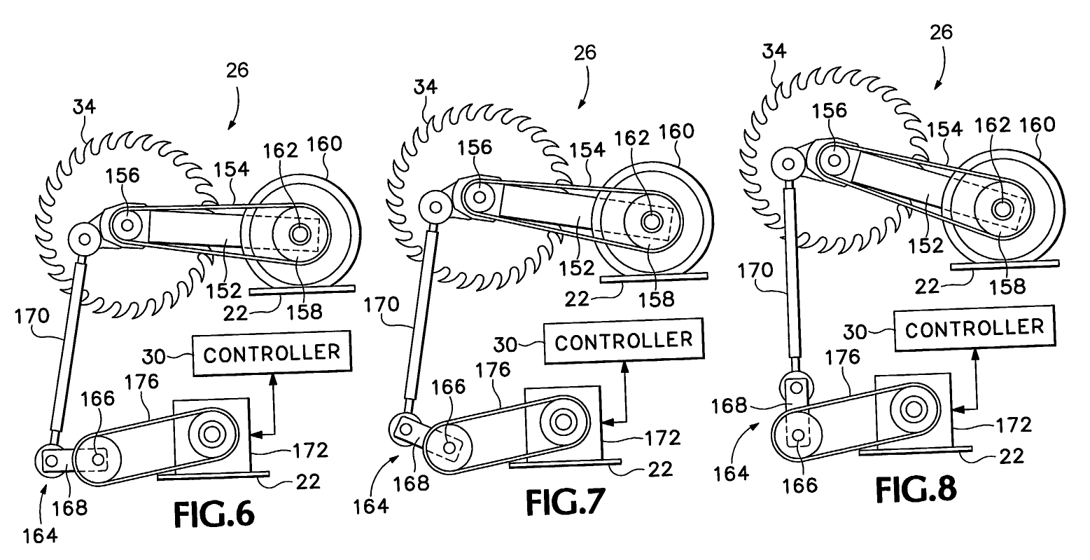

Referring to FIGS. 6-8, in the cutting mechanism 26 of the cutoff saw 20, the saw blade 34 is supported for rotation on a saw blade support arm 152. The saw blade 34 is rotated by a belt 154 that engages a blade drive pulley 156 and a motor pulley 158 attached to the armature 162 of a saw blade drive motor 160. The saw blade support arm 152 is arranged to pivot at one end about the same center as the armature shaft 162 of the saw blade drive motor 160. Since saw blade support arm 152 and the pulley 158 driving the rotation of the saw blade 34 rotate on a common center, belt tension is unaffected by rotation of the saw blade support arm.

To cut a workpiece, the rotating saw blade 34 reciprocates vertically to engage the blade's cutting elements with the workpiece 32 and then withdraw the saw blade so that the next workpiece can be positioned. As illustrated in FIGS. 6-8, reciprocation of the saw blade 34 is accomplished by oscillatory pivoting of the saw blade support arm 152 about the pivotal attachment to the cutoff saw. The saw blade support arm 152 is pivoted by a crank 164 comprising a shaft 166 and a crank arm 168. A connecting rod 170 is rotationally attached to the saw blade support arm 152 at a location remote from the pivotal attachment and to the crank arm 168. A servo motor 172, providing armature position feedback to the controller 30, rotates the crank 164 by way of a belt drive 176 that engages a pulley on the crank shaft 166.

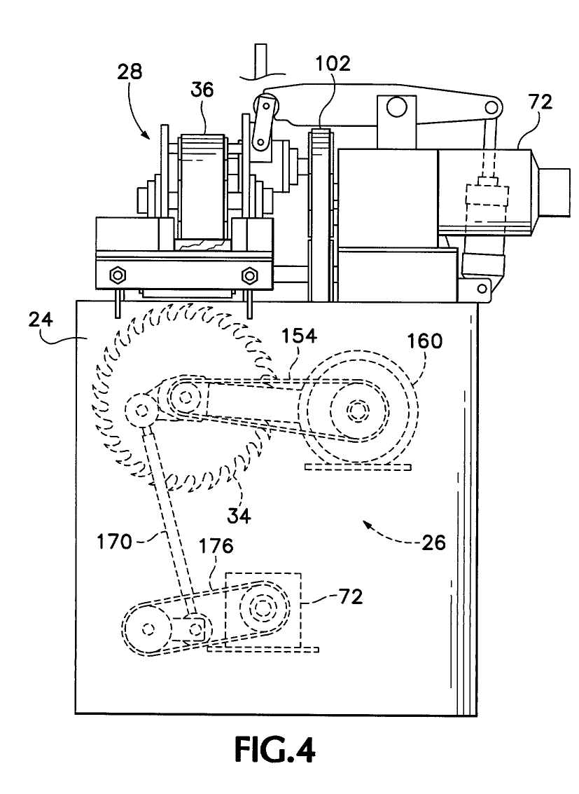

As illustrated in FIG. 6, with the crank arm 168 in an approximate horizontal starting position, or 270°, the saw blade 34 is positioned to begin a cutting cycle. A signal from the controller 30 causes the servo motor 172 to rotate the crank 164 from the starting position displacing the saw blade vertically upward to engage the workpiece. The saw blade 34 reaches its maximum upward displacement when the crank arm 168 is at 0° when the crank arm has rotated approximately one-fourth of a revolution, or 90°, as illustrated in FIG. 8. The circular displacement of the attaching point of the connecting rod 170 and crank arm 168 provides a smooth direction change at the limits of the cutting mechanism's travel which reduces shock and permits more rapid cycling of the cutting mechanism for improved cutoff saw throughput. Continued rotation of the crank 164 for an additional one-fourth of a revolution lowers the saw blade 34 to a height where the blade is just clear of the workpiece 32, as illustrated in FIG. 4. When the saw blade 34 is clear of the workpiece 32, the controller 30 starts the workpiece positioner motor 72 to drive the conveying belts and advance the next workpiece horizontally until the required length has advanced to the intersection with the cutting plane of the saw blade 34. The servo motor 172 continues to rotate the crank 164 toward the starting position. When the controller 30 determines from the armature position feedback from the servo motor 172 that the motor has rotated one revolution, the servo motor is shut off. When the controller 30 determines that the next workpiece is in position, the servo motor is restarted to reciprocate saw blade 34 for another cut.

The servo motor is capable of selectively adjusting the speed of the crank throughout a cutting cycle. Thus, the servo motor controls the speed so that the crank moves more slowly while cutting, but then accelerates rapidly once the board has been cut. For example, the servo motor may move slowly from 270° to 0° while cutting through the board, but then rapidly from 0° to 270° to return to the beginning of a cycle. By controlling the speed at which the crank rotates, the cutting mechanism is capable of achieving quicker cycle times and hence higher throughput, since the speed of the saw is not limited by the speed required to cut the board.

In addition, the use of the servo motor allows quicker cycle times due to the ability of the servo motor to accurately position the cutting saw. The servo motor is capable of accurately positioning the cutting saw to a position that is just beneath the board to be cut. For example, as shown in FIG. 6, the servo motor is capable of positioning the crank so that the crank arm is at 270° at the beginning of a cutting cycle. Preferably, the servo motor is capable of positioning the crank arm to within 2°, and preferably to within less than 10. When the crank arm is located at 270°, the cutting saw is located just underneath the board to be cut. The saw begins cutting before the crank has rotated 20°, and preferably less than 10°. Thus, when a board is positioned to be cut, the saw does not need to be lifted through a substantial gap to reach the board, but instead almost immediately engages the board at the beginning of a cutting cycle. This also serves to reduce the cycle time and achieve higher throughput.

Feedback regarding the position of the cutting saw may also be provided through the use of a sensor, such as an optical sensor. An optical sensor may be used to sense the location of the crank arm. The optical sensor may be positioned to locate when the crank arm has reached the position to begin a new cutting cycle, such as at 270°.

The cutoff saw 20 provides improved throughput by faster, more accurate positioning of the workpiece by the workpiece positioner and reduced cutting times for the cutting mechanism.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

1. A workpiece positioner for a cutoff saw comprising:
(a) a first conveying belt frictionally engaging a first portion of a first surface of a workpiece and arranged to convey said workpiece in a direction intersecting a cutting plane of said saw;
(b) a second conveying belt in frictional contact with a second surface, opposing said first surface, of said workpiece, said second conveying belt arranged to convey said workpiece in said direction intersecting said cutting plane in conjunction with said first conveying belt;
(c) a motor; and
(d) a transmission transferring power from said motor to drive said first and said second conveying belts in substantial synchronicity.

2. The apparatus of claim 1 further comprising:
(a) a third conveying belt in contact with a second portion of said first surface of said workpiece and arranged to convey said workpiece in said direction intersecting said cutting plane; and
(b) a second transmission transferring power from one of said first and said second conveying belts to drive said third conveying belt in substantial synchronicity with said first conveying belt.

3. The apparatus of claim 1 wherein said transmission comprises:
(a) a motor driven pulley;
(b) a first conveying belt drive pulley arranged to rotate a first conveying belt drive roller;
(c) a second conveying belt drive pulley arranged to rotate a second conveying belt drive roller; and
(d) a drive belt transferring power from said motor driven pulley to rotate said first and said second conveying belt drive pulleys in one direction at a substantially equal speed.

4. The apparatus of claim 3 further comprising:
(a) another driven pulley affixed to one of said first and said second drive pulleys for rotation therewith;
(b) a third conveying belt drive pulley arranged to rotate a third conveying belt drive roller; and
(c) a second drive belt transferring power from said another driven pulley to rotate said third drive pulley.

5. A cutting mechanism for an automatic cutoff saw, said cutting mechanism comprising:
(a) a saw blade arranged for powered rotation;
(b) a saw arm supporting said saw blade and pivotally attached to said cutoff saw at a first end of said saw arm;
(c) a crank including a shaft rotationally attached to said cut off saw and a crank arm;
(d) a connecting rod having a first end pivotally attached to said crank arm and a second end pivotally attached to said saw arm at a location remote from said first end of said saw arm such that rotation of said crank causes said saw arm to pivot about said first end; and
(e) a motor arranged to rotate said crank, said motor being controlled by a controller capable of controlling at least one of a speed and a position of said crank.

6. The apparatus of claim 5 wherein said pivotal attachment of said first end of said saw arm is arranged to pivot said saw arm about a center of rotation of an armature of a motor arranged to rotate said saw blade.

7. The cutting mechanism of claim 5 wherein said controller controls said position of said crank.

8. The cutting mechanism of claim 7 wherein said crank is positioned at the beginning of a cutting cycle so that the crank rotates less than 20° before said cutting saw engages a board.

9. The cutting mechanism of claim 5, wherein said controller provides a first speed of rotation of said crank during a first half of a cutting cycle, and a second speed of rotation of said crank during a second half of said cutting cycle.

10. The cutting mechanism of claim 5, further comprising a sensor.

11. A cut off saw comprising:
(a) a frame;
(b) a first conveying belt frictionally engaging a first portion of a first surface of a workpiece and arranged to convey said workpiece in a direction intersecting a cutting plane of a saw blade;
(c) a second conveying belt in frictional contact with a second surface, opposing said first surface, of said workpiece, said second conveying belt arranged to convey said workpiece in said direction intersecting said cutting plane in conjunction with said first conveying belt;
(d) a workpiece positioner motor;
(e) a transmission transferring power from said workpiece positioner motor to drive said first and said second conveying belts in substantial synchronicity;
(f) a saw blade arranged for powered rotation;
(g) a saw arm supporting said saw blade and attached to pivot relative to said frame at a first end;
(h) a crank including a shaft rotationally attached to rotate relative said frame and a crank arm;
(i) a connecting rod having a first end pivotally attached to said crank arm and a second end pivotally attached to said saw arm at a location remote from said first end so that rotation of said crank causes oscillatory pivoting of said saw arm about said first end; and
(j) a saw reciprocating motor arranged to rotate said shaft of said crank.
